(19) United States
(12) Patent Application Publication
(10) Pub. No.: US 2005/0070656 A1
(43) Pub. Date: Mar. 31, 2005

(54) Composition for optical sheet

(76) Inventor: Naoki Kodama, Osaka (JP)

Correspondence Address: FISH & RICHARDSON PC, 225 FRANKLIN ST, BOSTON, MA, 02110, US

(21) Appl. No.: 10/922,137

(22) Filed: Aug. 18, 2004

(30) Foreign Application Priority Data
Sep. 30, 2003 (JP) 2003-339113

(51) Int. Cl. C08L 1/00

(52) U.S. Cl. 524/493; 524/556

(57) ABSTRACT

As a means to prevent an optical sheet from being warped, a composition for an optical sheet is provided. The composition includes (A) a copolymer containing at least one repeating unit selected from the group consisting of a repeating unit derived from a (meth) acrylic ester possessing a cycloalkyl group, a repeating unit derived from an iso-butyl (meth) acrylate, and a repeating unit derived from a tert-butyl (meth)acrylate; (B) a light-diffusing agent; and (C) an inorganic particle.

### TECHNICAL FIELD

The present invention relates to an optical sheet for forming a backlight unit in a liquid crystal display device. The present invention, in particularly, relates to a composition for an optical sheet which is used for the production of an optical sheet.

### BACKGROUND OF THE INVENTION

In recent years, the demand for liquid crystal display devices has been greatly increasing. The liquid crystal display devices possess such characteristics as low reflection, smallness of wall thickness, and low power consumption. Moreover, the liquid crystal display devices are capable of producing digital displays and are suitable for displaying digital signals.

In the structures for the liquid display devices, the backlight mode is widely adopted. In the liquid crystal display device adopting the backlight style, the liquid crystal layer is illuminated from behind to display a prescribed image on the surface thereof. On the back surface of the liquid crystal layer, a backlight unit adapted to illuminate the liquid crystal layer uniformly is disposed. The backlight unit is composed of a lamp, a light guide plate, a light-diffusing sheet, a prism sheet, etc. The light radiated from the lamp is diffused by the light guide plate and injected into the light-diffusing sheet. The light which has been injected into the light-diffusing sheet is uniformly diffused in the light-diffusing sheet and then injected into the prism sheet. The light which has been injected into the prism sheet is modulated by the refraction in the prism sheet into a light which exhibits a peak in the vertical direction to the light crystal layer. Generally, a sheet which is possessed of one or more optical functions such as a function of diffusing light and a function of protecting a prism sheet is called an optical sheet.

The optical sheet which is possessed of a function of diffusing light among these optical functions brings a great influence on the unevenness of luminance. Specifically, when the light diffusion is not sufficient, a portion having a large illumination and a portion having a small illumination occur and a bright portion and a dark portion are formed on the image plane. The ordinary optical sheet which is possessed of a function of diffusing light is endowed with a structure having beads dispersed as a light-diffusing agent in a binder formed of a translucent synthetic resin. The beads diffuse the light passing through the optical sheet, and inject the light uniformly onto the liquid crystal layer.

The optical sheet which is formed of the synthetic resin, however, has the possibility of being deformed by the heat. Particularly, the portion of the optical sheet which is located closely to the lamp as the light source is exposed to a temperature in the approximate range of 80 to 90° C. owing to the heat emitted by the lamp. The problem, therefore, ensues that the optical sheet will be warped by the heat and the image plane will give rise to uneven luminance.

As a measure for solving this problem, a procedure which consists in dispersing inorganic particle having an organic polymer fixed on the surface thereof in a binder which forms the optical sheet has been proposed (refer to JP-A-2001-318210, for example). By having the inorganic particle dispersed, it is made possible to enhance the heat resistance of the optical sheet and repress the occurrence of uneven luminance on the image plane. Further, by having the organic polymer fixed on the surface of the inorganic particle, it is made possible to enhance the affinity between the inorganic particle and the binder and ensure proper dispersion of the inorganic particle in the binder.

With the object of repressing the occurrence of uneven luminance on the image plane, however, the desirability of developing a means to prevent more effectively the optical sheet from being warped has been being desired.

Generally as the binder, a various polymers are used in conformity with the characteristic property which the binder is required to possess. For example, the copolymer synthesized by using a compound represented by the following formula: 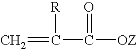
(wherein R is selected from the group consisting of hydrogen atom, methyl group, and ethyl group, and Z denotes an optionally substituted cycloalkyl group), iso-butyl methacrylate, and tert-butyl methacrylate has been disclosed as monomers (refer to JP-A-H11-5940, for example). According to JP-A-H11-5940, the use of this copolymer as the binder results in imparting an improved bending property to the coated film, and the inclusion of fine composite particle enables the coated film to manifest a self-cleaning property.

The composition disclosed in JP-A-H11-5940, however, is directed toward a coating medium. The fact that this copolymer excels as a binder for forming a light-diffusing layer has never been known hitherto.

### DISCLOSURE OF THE INVENTION

It is an object of the present invention to provide a novel means to prevent the optical sheet from being warped.

In an aspect of the invention, a composition for an optical sheet includes (A) a copolymer containing at least one repeating unit selected from the group consisting of a repeating unit derived from a (meth) acrylic ester possessing a cycloalkyl group, a repeating unit derived from an iso-butyl (meth) acrylate, and a repeating unit derived from a tert-butyl (meth)acrylate; (B) a light-diffusing agent; and (C) an inorganic particle.

By using a copolymer possessing this structure as the binder, it is made possible to impart an enhanced heat resistance to the optical sheet to be produced. Consequently, the adverse effects caused by heat, namely the warping of the optical sheet and the generation of uneven luminance on the image plane, can be effectively repressed.

### BRIEF DESCRIPTION OF THE DRAWING

FIG. 1 is a cross-sectional view of an optical sheet composed of a substrate and a light-diffusing layer laminated to the surface of the substrate.

### BEST MODE FOR CARRYING OUT THE INVENTION

The present invention relates to an optical sheet, which includes (A) a copolymer containing at least one repeating unit selected from among a repeating unit derived from a (meth)acrylic ester possessing a cycloalkyl group, a repeating unit derived from an iso-butyl (meth) acrylate, and a repeating unit derived from a tert-butyl (meth)acrylate, (B) a light-diffusing agent, and (C) an inorganic particle.

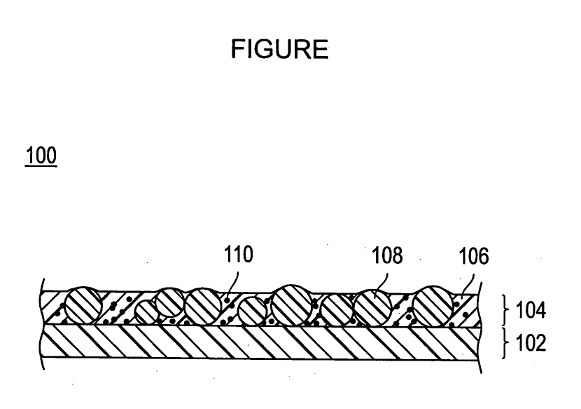

First, the general structure of the optical sheet which possesses a light-diffusing function will be briefly explained with reference to the drawing. FIG. 1 is a cross-sectional view of an optical sheet 100 which is composed of a substrate 102 and a light-diffusing layer 104 laminated on the surface of the substrate 102. The substrate 102 is formed of a transparent material so as to transmit light. In the light-diffusing layer 104, the light injected into the optical sheet is diffused. The composition of the present invention for the optical sheet is used for forming the light-diffusing layer 104. The light-diffusing layer 104 is composed of a binder 106, a light-diffusing agent 108 and an inorganic particle 110 dispersed in the binder 106. By the light-diffusing agent 108, the injected light is uniformly scattered. By the in organic particle 110, the heat resistance of the light-diffusing layer 104 is enhanced.

As the binder 106 in the present invention, (A) a copolymer which contains at least one repeating unit selected from the group consisting of a repeating unit derived from a (meth)acrylic ester possessing a cycloalkyl group, a repeating unit derived from an iso-butyl (meth) acrylate, and a repeating unit derived from a tert-butyl (meth)acrylate.

The enhancement of the heat resistance of the light-diffusing layer brought about by the use of this copolymer as the binder for forming the light-diffusing layer may be ascribed to the influence of the prescribed functional group which is contained in the copolymer. To be specific, it is inferred that the inclusion of such a functional group as cycloalkyl group, iso-butyl group, or tert-butyl group results in effectively elevating the glass transition temperature (Tg) of the copolymer and consequently enhancing the heat resistance of the light-diffusing layer. In consequence of the elevation of the glass transition temperature of the copolymer, the hardness of the light-diffusing layer can be also exalted.

To the warping of the optical sheet, not only heat but also humidity can contribute. That is, when the optical sheet is deficient in moisture resistance, this optical sheet tends to warp to the extent of compelling the image plane to generate uneven luminance. No sufficient study has been made hitherto regarding the relation between the moisture resistance and the warping of the optical sheet. By using the composition of the present invention for the optical sheet, it is further made possible to enhance the moisture resistance of the optical sheet. Though the mechanism which is responsible for the enhancement of the moisture resistance in consequence of the use of the aforementioned copolymer as the binder for forming the light-diffusing layer has not been fully elucidated, it may be inferred that the moisture resistance of the light-diffusing layer is affected by the hydrophobicity of such functional group as cycloalkyl group, iso-butyl group, and tert-butyl group. Specifically, since this functional group possesses high hydrophobicity, the use of the copolymer containing this functional group as the binder is thought to result in enhancing the moisture resistance of the light-diffusion layer. The technical scope of the present invention, however, is not restricted to an embodiment which possesses this mechanism.

Further by using the composition of the present invention for the optical sheet, it is made possible to exalt the hardness and the resistance to ultraviolet light of the optical sheet to be formed.

The concept of the copolymer to be used as the binder in the present invention embraces the copolymers which are known to the art. It is permissible to use the copolymers disclosed in the JP-A-H11-5940, for example, as the binder which is used in the present invention. The composition disclosed in JP-A-H11-5940 is directed toward a coating medium as already pointed out. The fact that this copolymer excels in quality as a binder for forming a light-diffusing layer, however, has not been known. Further, the relation between the binder and the moisture resistance has not been known. Unlike the coating film which is formed on the surface of a steel plate, the optical sheet which is used in the liquid crystal display device is very sensitive to flexure. Thus, the present invention which has originated in the discovery of the fact that the copolymer possessing the prescribed structure is useful as the binder for an optical sheet and has consequently accomplished the enhancement of the durability of the optical sheet is greatly effective.

Now, the components which the composition of the present invention for the optical sheet contains will be explained in detail below.

The composition of the present invention for the optical sheet includes a copolymer which contains at least one repeating unit selected from the group consisting of a repeating unit derived from a (meth) acrylic ester possessing a cycloalkyl group, a repeating unit derived froman iso-butyl (meth) acrylate, and a repeating unit derived from a tert-butyl (meth)acrylate.

First, the repeating unit which derived from a (meth)acrylic ester possessing a cycloalkyl group will be explained. The expression “the repeating unit derived from a (meth)acrylic ester possessing a cycloalkyl group (hereinafter occasionally described as ‘cycloalkyl-containing repeating unit’) means a repeating unit which is obtained when a (meth) acrylic ester possessing at least one cycloalkyl group is polymerized as a monomer. The use of a copolymer which contains a repeating unit possessing a cycloalkyl group results in enhancing the heat resistance, the moisture resistance, and the hardness of an optical sheet.

Preferably, the cycloalkyl-containing repeating unit is a repeating unit which is represented by the following formula (1).

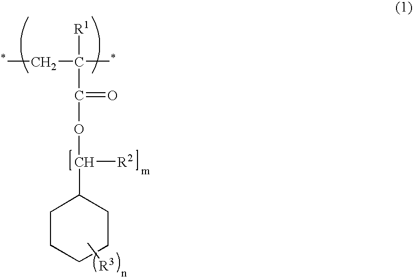

In this formula, R¹ denotes hydrogen atom or methyl, R² denotes hydrogen atom, methyl or ethyl, and R³ denotes an organic group which is directly bound to the cyclohexyl group shown in the formula (1). As concrete examples of the organic group, linear, branched, or cyclic alkyl of 1 to 10 carbon atoms, hydroxyalkyl of 1 to 5 carbon atoms, alkoxyalkyl of 1 to 5-carbon atoms, acetoxyalkyl of 1 to 5 carbon atoms, and halogenated (for example, chlorinated, brominated, or fluorinated) alkyl of 1 to 5 carbon atoms are cited. Of these organic groups, alkyl of 1 to 4 carbon atoms, hydroxyalkyl of 1 to 2 carbon atoms, alkoxyalkyl of 1 to 2 carbon atoms, and acetoxyalkyl of 1 to 2 carbon atoms are preferably used.

As concrete examples of the linear, branched, or cyclic alkyl of 1 to 10 carbon atoms, methyl, ethyl, n-propyl, iso-propyl, n-butyl, iso-butyl, tert-butyl, pentyl, hexyl, cyclohexyl, heptyl, octyl, nonyl, and decyl are cited. As concrete examples of the hydroxyalkyl of 1 to 5 carbon atoms, hydroxymethyl, 1-hydroxyethyl, 2-hydroxyethyl, and 3-hydroxypropyl are cited. As concrete examples of the alkoxyalkyl of 1 to 5 carbon atoms, methoxymethyl, ethoxymethyl, 1-methoxymethyl, and 2-methoxyethyl are cited. As concrete examples of the acetoxyalkyl of 1 to 5 carbon atoms, acetoxymethyl, 1-acetoxyethyl, 2-acetoxyethyl, and 3-acetoxypropyl are cited. As concrete examples of the halogenated alkyl of 1 to 5 carbon atoms, trifluoromethyl, trichloromethyl, tribromomethyl, 1-fluoroethyl, and 1,1-difluoroethyl are cited.

Then, m denotes an integer of 0 to 4, and n denotes an integer of 0 to 2. When m is 2 or more, the R² may be identical with or different from each other. When n is 2 or more, the R³ may be identical with or different from each other. When n is 2 or more, the R³ may jointly form a ring. For example, two R³ may be used to form a ring so that the cyclohexyl group moiety shown in the formula (1) may constitute an isobornyl. The position of substitution of R³ to the cyclohexyl group is not particularly restricted. When n is 1 or more, it is preferable that at least one of the R³ be bonded to the 3 position or 4 position of the cyclohexyl group. It may occur at times that n is 0, namely no substituent is present on the cyclohexyl group.

The cycloalkyl-containing repeating unit represented by the formula (1) maybe formed of such monomers as cyclohexyl (meth)acrylate, cyclohexylmethyl (meth)acrylate, cyclohexylethyl (meth)acrylate, cyclohexylpropyl (meth)acrylate, cyclohexylbutyl (meth)acrylate, 4-methylcyclohexylmethyl (meth)acrylate, 4-ethylcyclohexylmethyl (meth)acrylate, isobornyl (meth)acrylate, and 4-hydroxymethylcyclohexylmethyl (meth)acrylate. The monomers which are usable for the purpose of forming a cycloalkyl group-containing monomer unit, however, are not restricted to the examples just enumerated. Among the monomers cited above, cyclohexyl (meth)acrylate, cyclohexylmethyl (meth)acrylate, and 4-methylcyclohexylmethyl (meth) acrylate are preferably used. The repeating unit represented by the formula (1) is preferred to be such that R¹ is hydrogen atom or methyl, R² is hydrogen atom, R³ is methyl, m is 0 or 1, and n is 0 or 1.

The copolymer which is contained in the composition of the present invention for the optical sheet may contain a repeating unit which derived from an iso-butyl (meth) acrylate. The expression “repeating unit derived from an iso-butyl (meth) acrylate” means a repeating unit which is represented by the formula, “—CH₂—CH(COOCH₂CH(CH₃)₂)—” or “—CH₂—C(CH₃) (COOCH₂CH(CH₃) ₂)—.” The use of a copolymer containing a repeating unit derived from an iso-butyl (meth)acrylate results in exalting the heat resistance, the moisture resistance, and the hardness of the optical sheet.

The copolymer contained in the composition of the present invention for the optical sheet may contain a repeating unit which derived from a tert-butyl (meth)acrylate. The expression “repeating unit derived from a tert-butyl (meth)acrylate” means a repeating unit which is represented by the formula, “—CH₂—CH(COOC(CH₃)₃)-” or “—CH₂—C(CH₃) (COOC(CH₃)₃)—. ” The use of a copolymer containing a repeated unit derived from a tert-butyl (meth)acrylate results in exalting the heat resistance, the moisture resistance, and the hardness of the optical sheet.

The copolymer contained in the composition for the optical sheet contains at least one repeating unit selected from the group consisting of a repeating unit derived from an a (meth)acrylic ester possessing a cycloalkyl group, a repeating unit derived from an iso-butyl (meth) acrylate, and a repeating unit derived from an a tert-butyl (meth) acrylate.

The copolymer contained in the composition for the optical sheet may contain other repeating unit. As concrete examples of the monomer which can be used for the purpose of synthesizing the copolymer, polymerizing unsaturated monomers with a carboxyl group such as (meth) acrylic acid, maleic acid, and maleic anhydride; alkyl (meth) acrylates such as methyl (meth)acrylate, ethyl (meth)acrylate, propyl (meth)acrylate, iso-propyl (meth)acrylate, n-butyl (meth)acrylate, 2-ethylhexyl (meth)acrylate, lauryl (meth)acrylate, and stearyl (meth)acrylate; polymerizing unsaturated monomers with hydroxy group such as 2-hydroxyethyl (meth)acrylate, 4-hydroxybutyl (meth)acrylate, and caprolacton-modified hydroxy (meth)acrylate; polymerizing unsaturated monomers with sulfonic acid group such as vinyl sulfonic acid, styrene sulfonic acid, and sulfoethyl (meth)acrylate; acidic phosphoric-ester-type polymerizing unsaturated monomers such as 2-(meth)acryloyloxyethyl acid phosphate, 2-(meth)acryloyloxypropyl acid phosphate, and 2-methacryloyloxyethyl phenyl phosphoric acid; polymerizing unsaturated monomers with epoxy group such as glycidyl (meth)acrylate; polymerizing unsaturated monomers with a nitrogen atom such as (meth)acrylamide and N,N′-dimethylaminoethyl(meth)acrylate; polymerizing unsaturatedmonomers withahalogen atom such as vinyl chloride and vinylidene chloride; aromatic polymerizing unsaturated monomers such as styrene, α-methylstyrene, and vinyl toluene; vinyl esters such as vinyl acetate, vinyl ethers; and unsaturated cyanogen compounds such as (meth)acrylonitrile are cited. The monomers to be used and the amounts of their incorporation in the copolymer may be decided in consideration of such characteristic properties as heat resistance, moisture resistance, and hardness which the optical sheet is expected to possess.

The content of each repeating unit in the copolymer is not particularly restricted. Properly for the purpose of effectively preventing the optical sheet from warping, the total amount of a cycloalkyl group-containing repeating unit, a repeating unit derived from an iso-butyl (meth)acrylate, and a repeating unit derived from a tert-butyl (meth) acrylate in the copolymer is preferably 5.0 to 98.0 mass %, and more preferably 30.0 to 80.0 mass %, based on the mass of the polymerizing unsaturated monomer.

No particular restriction is imposed on the method for the production of the copolymer. A proper method may be selected to suit the kind of a monomer to be polymerized and the working environment. The method described in the working example cited herein below may be adopted, for example. Optionally, a commercially available copolymer may be used as occasion demands.

The content of the copolymer in the composition for the optical sheet is not particularly restricted. This content may be decided in consideration of the working property, the working environment, and the physical properties of the copolymer. A decrease in the viscosity of the composition for the optical sheet, for example, is attained by increasing the content of the solvent and decreasing proportionately the content of the copolymer.

The composition of the present invention for the optical sheet contains a light-diffusing agent. By having the light-diffusing agent contained in the optical sheet, the optical sheet can manifest the function of diffusing light. The light-diffusing agent is not particularly restricted but, is only required to be a material possessing the function of diffusing light. The light-diffusing agent can be formed of acrylic resin, polyurethane, polyvinyl chloride, polystyrene, polyacrylonitrile, and polyamide, for example. For the sake of increasing the amount of the light which the optical sheet transmits, the light-diffusing agent is preferred to be transparent. The light-diffusing agent is generally spherical. The method for procuring the light-diffusing agent is not particularly restricted.

The average particle diameter of the light-diffusing agent is preferably in the range of 1 to 50 μm and more preferably 2 to 20 μm. If the average particle diameter of the light diffusion agent is unduly small, the shortage will possibly result in preventing the effect of light diffusion from being fully manifested. Conversely, if the average particle diameter of the light-diffusing agent is unduly large, the overage will possibly render application of the composition for the optical sheet difficult.

The amount of the light-diffusing agent in the composition is preferred to be in the range of 10 to 80 mass %, and more preferably 10 to 75 mass %, based on the total mass of the copolymer to be used as the binder and the light-diffusing agent. If the amount of the light-diffusing agent is unduly small, the shortage will possibly result in preventing the effect of light diffusion from being fully manifested. Conversely, if the amount of the light-diffusing agent is unduly large, the overage will possibly render application of the optical sheet composition difficult.

The composition of the present invention for the optical sheet contains an inorganic particle. The inorganic particle is a particle of an inorganic compound formed of arbitrary elements. By having the inorganic particle contained in the optical sheet, the optical sheet acquires an exalted heat resistance. Though the inorganic compound which forms the inorganic particle is not particularly restricted, it is preferred to be an inorganic oxide. The term “inorganic oxide” as used herein is defined as an oxygen-containing metal compound having the metal element thereof bound in the shape of a three-dimensional network via the oxygen atom. Incidentally, in the present invention, the concept of “metal element” embraces silicon. The metal element forming the inorganic oxide is preferred to be a metal element selected from the elements belonging to Groups 2 to 16, more preferably from the elements belonging to Groups 3 to 5, in the Periodic Table. The metal element selected from the group consisting of Si, Al, Ti, and Zr is particularly favorable. The colloidal silica having Si as the metal element proves most favorable. The colloidal silica is produced relatively easily and is inexpensive. The inorganic particle may be manufactured based on the procedure described in a working example described below, or a commercially available inorganic particle may be used.

The shape of the inorganic particle is not particularly restricted, but are allowed to assume any shape selected from various known shapes such as spheres, needles, plates, scales, and broken fragments. It is permissible to use two or more kinds of inorganic particle in combination.

The amount of the inorganic particle to be incorporated is preferably in the range of 10 to 70 mass %, more preferably 25 to 50 mass %, based on the total mass of the copolymer used as the binder and the inorganic particle. If the amount of the inorganic particle is unduly small, the shortage will possibly keep the optical sheet from being satisfactorily protected against thermal deformation. Conversely, if the amount of the inorganic particle is unduly large, the overage will possibly render application of the composition for the optical sheet difficult or result in degrading the ability of the produced optical sheet to transmit the light.

The inorganic particle is preferably complex particle which results from having an organic polymer fixed on the surface thereof. By having the organic polymer fixed on the surface of the inorganic particle, it is made possible to enhance the dispersibility of the inorganic particle in the binder and the affinity of the inorganic particle for the binder, and consequently exalt the ability of the produced optical sheet to transmit the light. The term “fix” as used herein does not mean simple adhesion and attachment but means the formation of a chemical linkage between the organic polymer and the inorganic particle. When the inorganic particle is washed with a cleaning fluid, therefore, the organic polymer is not substantially detected in the washing. The inorganic particle may have the organic polymer included in the particle. In consequence of this inclusion, the core of the inorganic particle is endowed with proper softness and toughness.

The term “organic polymer” as used herein means a polymer which is formed of an organic component. It is not particularly restricted on account of molecular weight, shape, composition, and the presence or absence of a functional group. As concrete examples of the resin which forms the organic polymer, (meth)acrylic resin; polystyrene; polyvinyl acetate; polyolefin such as polyethylene and polypropylene; and polyesters such as polyvinyl chloride, polyvinylidene chloride, and polyethylene terephthalate; and their copolymers are cited. These organic polymers may be partially modified with such functional groups as amino group, epoxy group, hydroxyl group, and carboxyl group.

The average particle diameter of the complex particle is preferably in the range of 5 to 200 nm, more preferably 5 to 100 nm. If the average particle diameter of the complex particle is unduly small, the shortage will possibly dispose the complex particle to undergo ready cohesion owing to an increased surface activity. Conversely, if the average particle diameter of the complex particle is unduly large, the overage will possibly result in degrading the transparency of the optical sheet. The term “average particle diameter” as used herein means a volume-average particle diameter. The average particle diameter of the complex particle can be determined by a known means of determination such as, for example, a means described in a working example described herein below.

The composition for the optical sheet incorporates therein a prescribed amount of complex particle. The coefficient of variation of the particle diameter of the complex particle is preferably not more than 50% and more preferably not more than 30%. The coefficient of variation of the particle diameter of the complex particle is defined as the value calculated by dividing the standard deviation of the particle diameter of the complex particle by the average particle diameter of the complex particle. The coefficient of variation serves as an index which increases in proportion as the magnitude of dispersion of particle diameters increases. The coefficient of variation, for example, is determined by a method which is described in a working example described herein below.

The content of the organic polymer in the complex particle is not particularly restricted. It, however, falls preferably in the range of 0.5 to 50 mass %, based on the mass of the inorganic particle.

The composition of the present invention for the optical sheet may further contain a multifunctional isocyanate compound. When it contains a multifunctional isocyanate compound and further contains a component with a hydroxyl group, a cross-linked structure is formed between the multifunctional isocyanate compound and the component with a hydroxyl group. As a result, the properties of the produced optical sheet such as the moisture resistance, the flexibility, and the durability can be further enhanced.

Specifically, the cross-linking reaction can be advanced by using an organic polymer with a hydroxyl group as the organic polymer to be fixed on the surface of inorganic particle and adding a multifunctional isocyanate compound into the composition for the optical sheet. The cross-linking reaction can be advanced also by using a copolymer with a hydroxyl group as the copolymer and adding the multifunctional isocyanate compound into the composition for the optical sheet. By the introduction of the cross-linked structure, the properties of the optical sheet such as the hardness and the resistance to a solvent can be exalted. In the copolymer with a hydroxyl group, the average hydroxyl value is preferably in the range of 10 to 200 and more preferably 20 to 100. If the hydroxyl value is unduly small, the shortage will possibly prevent the cross-linkage from proceeding sufficiently and the properties from being exalted sufficiently. Conversely, if the hydroxyl value is unduly large, the overage will possibly result in degrading the moisture resistance. Incidentally, the number average molecular weight of the copolymer with a hydroxyl group is preferably in the range of 1000 to 50000 and more preferably 3000 to 10000.

As the multifunctional isocyanate compound, aliphatic, alicyclic, aromatic, and other multifunctional isocyanate compounds and their modified compounds may be used. As concrete examples of the multifunctional isocyanate compound, trimers such as biuret modifications or isocyanurate modifications of tolylene diisocyanate, xylylene diisocyanate, diphenyl methane diisocyanate, hexamethylene diisocyanate, isophoronediisocyanate, lysine diisocyanate, 2,2,4-trimethylhexyl methane diisocyanate, methylcyclohexane diisocyanate, or 1,6-hexamethylene diisocyanate; and compounds formed by the reaction of such multifunctional isocyanates with polyhydric alcohols such as propane diol, hexane diol, polyethylene glycol, and trimethylol propane and allowed to retain two or more isocyanate groups; and blocked multifunctional isocyanate compounds formed by blocking such multi functional isocyanate groups with such blocking agents as alcohols like ethanol and hexanol, compounds with a phenolic hydroxyl group like phenol or cresol, oximes like acetoxide and methylethyl ketoxime, and lactams like ε-caprolactam and γ-caprolactam are cited. These multifunctional isocyanate compounds may be used either singly or in the form of a mixture of two or more members.

When the composition for the optical sheet contains a multifunctional isocyanate compound, this composition for the optical sheet is preferred to contain further a curing catalyst for the purpose of promoting the cross-linking reaction. As concrete examples of the curing catalyst, tertiary amines such as triethyl amine and triethylene diamine and organic tin compounds such as dibutyl tin dilaurate, dibutyl tin diacetate, and stannous octoate are cited. Optionally, this curing catalyst may be used in combination with a promoter.

The composition of the present invention for the optical sheet may optionally contain other additives. As concrete examples of such additives, resins such as polyester resin, epoxy resin, fluorocarbon resin, silicone resin, urethane resin, polyether resin, and alkyl resin; plasticizers; stabilizers; antidegradants; dispersants; and antistatic agents are cited.

During the manufacturing process of the optical sheet by using the composition of the present invention for the optical sheet, the light-diffusing layer is formed by applying a solution containing the components of the optical sheet and drying the applied layer of the solution. The solvent in this case may be selected by taking into consideration the solubility, workability, and cost of each component. As concrete examples of the solvent, aromatic hydrocarbon type solvents such as toluene and xylene; aliphatic hydrocarbon type solvents such as n-hexane and n-heptane; ester type solvents such as ethyl acetate and n-butyl acetate; ketone type solvents such as methylethyl ketone and methylisobutyl ketone; alcohol type solvents such as isopropyl alcohol and butyl alcohol; and petroleum fractions with various boiling points having aliphatic hydrocarbons as main components are cited. Incidentally, the solvents are not restricted to the above examples. The solvent may be used either singly or in the form of a mixture of two or more members. When the composition is expected to involve an isocyanate cross-linkage therein, it is preferred to avoid using an alcohol type solvent because the alcohol type solvent reacts with isocyanate.

The composition of the present invention for the optical sheet is used for the purpose of producing an optical sheet. The conditions for the production of the optical sheet and the other materials for forming the optical sheet are not particularly restricted. The optical sheet can be manufactured by consulting accumulated knowledge and developed techniques.

### EXAMPLES

Now, the effects of the present invention will be explained below with reference to working examples. The term “part” means “part by mass” unless otherwise specified.

(Synthesis of Copolymer (1))

In a four-neck flask provided with a stirrer, a thermometer, a cooler, a dropping funnel, and a nitrogen gas tube, n-butyl acetate (100 parts) was placed as a solvent and heated to a reflux temperature. Then, while introduction of nitrogen gas was continued, a monomer mixture composed of cyclohexyl methacrylate (40 parts), n-butyl methacrylate (37.7 parts), n-butyl acrylate (7.3 parts), 2-hydroxyethyl methacrylate (13.9 parts), and methacrylic acid (1.1 parts) as monomers and tert-butylperoxy-2-ethylhexanoate (3.0 parts; sold by Nippon Oils & Fats Co., Ltd. under the trademark designation of “Perbutyl O”) as a polymerization initiator was dropped into the refluxed solvent through a dropping funnel over a period of three hours. Further, 1,1-bis (tert-butylperoxy)-3,3,5-trimethyl cyclohexane (0.2 part; soldbyNipponOils and Fats Co., Ltd. under the trademark designation of “Perhexa 3M”) was added three times 30 minutes apart and retained at the reflux temperature for two hours. Thereafter, the resultant solution was cooled to room temperature to obtain the solution of copolymer (1). The copolymer (1) had a number average molecular weight (Mn)/weight average molecular weight (Mw)=5300/10500.

(Synthesis of Copolymers (2) to (11))

The solutions of copolymers (2) to (11) were obtained by following the procedure of Synthesis of copolymer (1) while varying the composition of components in a monomer mixture to the compositions shown in Table 1. The copolymer (10) and the copolymer (11) contain none of the cycloalkyl group-containing repeating unit, the repeating unit derived from an iso-butyl (meth)acrylate, and the repeating unit derived from a tert-butyl (meth) acrylate as a repeating unit.

The symbols found in Table 1 have the following meanings.
CHMA Cyclohexyl methacrylate
CHMMA Cyclohexyl methyl methacrylate
4M-CHMMA 4-Methyl cyclohexyl methyl methacrylate
IBMA iso-Butyl methacrylate
TBMA tert-Butyl methacrylate
MMA Methyl methacrylate
nBMA n-Butyl methacrylate
BA n-Butyl acrylate
2EHA 2-Ethylhexyl acrylate
HEMA 2-Hydroxyethyl methacrylate
MAA Methacrylic acid

Further, the glass transition temperature (Tg) of the copolymers are additionally shown in Table 2.

(Glass Transition Temperature (Tg))

The Tg of a copolymer was calculated from the following Fox formula.
1/Tg=Σ(Wn/Tgn)/100

In this formula, Wn denotes mass % of monomer n existing in 100 mass % of copolymer, and Tgn denotes the glass transition temperature Tg (absolute temperature) of a homopolymer formed of a monomer n.

(Synthesis of Complex Particle)

A disperse liquid in which complex particle was dispersed in n-butyl acetate was obtained by following the method disclosed in Paragraphs “0056” to “0061” of the JP-A-H11-5940. The concentration of the complex particle was 30.0 mass % and the content of the inorganic component in the complex particle was 57.8 mass %. The average particle diameter of the complex particle was 55 nm and the coefficient of variation was 18.0%. As the alkoxy group present in the complex particle, methoxy group was contained at a ratio of 0.12 mol/g. Further, the complex particle showed good temporal stability. When the disperse liquid of complex particle was centrifuged and the resultant supernatant was analyzed by GPC, no residue of the organic polymer was detected. When the fractions of complex particle obtained as sediments by centrifuging the complex particle were washed with THF or water and the washing liquid was analyzed by GPC, no residue of the organic polymer was detected. These results indicate that the complex particle had the organic polymer not simply attached but strongly fixed to the inorganic particle.

As regards the disperse liquid of the complex particle, the concentration of the complex particle in the produced disperse liquid, the content of an inorganic component in the complex particle, the average particle diameter, the coefficient of variation of the complex particle, the alkoxy group content in the complex particle, and the temporal stability were analyzed and rated by the following methods.

(Concentration of Complex Particle)

The disperse liquid was dried under the pressure of 100 mmHg at 130° C. for 24 hours, and the concentration of complex particle was calculated by the following formula.

Concentration of complex particle (wt %)=100×D/W (wherein D denotes the weight (g) of complex particle after the drying, and W the weight (g) of the disperse liquid of complex particle before the drying).

(Content of Inorganic Component in Complex Particle)

The disperse liquid was dried under the pressure of 100 mmHg at 130° C. for 24 hours, and the dried resultant was subjected to element analysis. The ash content was deemed to be the content of inorganic component in complex particle.

(Average Particle Diameter)

The average particle diameter was determined at 23° C. by the dynamic light scattering method using the following device. It was obtained as a volume-average particle diameter.

Device: Submicron particle diameter analyzer (sold by Nozaki Sangyo K. K. under the trademark designation of NICOMPMODEL 370″).

Sample used for the determination: A dispersed liquid having complex particle dispersed in a concentration of 0.1 to 2.0 mass % in tetrahydrofuran (where the organic polymer in the complex particle was insoluble in tetrahydrofuran, a solvent capable of dissolving the organic polymer was used instead).

(Coefficient of Variation)

The coefficient of variation was calculated in accordance with the following formula.

$$Cofficient of variation ( \% ) = \frac{Standard deviation of diameters of complex particle}{Average particle diameter of complex particle}$$

(Alkoxy group content in complex particle)

The dispersed liquid including the complex particle was dried under the pressure of 100 mmHg at 130° C. for 24 hours. 5 g of the dried resultant was dispersed in a mixture of 50 g of acetone and 50 g of an aqueous 2N-NaOH solution, and the obtained dispersed liquid was stirred at room temperature for 24 hours. Thereafter, alcohol in the liquid was quantitatively analyzed by means of gas chromatography to calculate the alkoxy group content in complex particle.

(Temporal Stability)

A given dispersed liquid was sealed in a Gardner viscosity tube and retained at 50° C. A sample showing no discernible sign of aggregation and sedimentation of particle and elevation of viscosity after one month's storage was rated as “good”.

### EXAMPLE 1

The synthesized disperse liquid including complex particle in n-butyl acetate and a solution of Copolymer (1) were prepared and were mixed in the proportion of 40 mass % of the inorganic oxide content in the solid component obtain a solution containing the Copolymer (1) and the complex particle. To the solution, acrylic resin beads having an average particle diameter of 5 μm (sold by Sekisui Plastics Co., Ltd. under the product code of “MBX-5”) was further added as a light-diffusing agent in an amount of 30 mass % based on the solution of the copolymer. Thereafter, a multifunctional isocyanate (sold by Sumika Bayer Urethane K. K. under the trademark designation of “Sumidur N3200”) weighed out in an amount to satisfy OH group/NCO group=1 (equivalent weight ratio) was incorporated therein. The resultant composition for an optical sheet was applied in an amount estimated to form a dry film 15 μm thick with a bar coater onto a substrate composed of polyethylene terephthalate film 100 μm thick. The resultant coated film was left standing at room temperature for one hour and then forced dried at 80° C. for two hours to complete an optical sheet.

The optical sheet thus obtained was tested for total light transmittance, haze, luminance, heat resistance, and moisture resistance. The results are shown in Table 2. These properties were determined as follows.

(Surface Hardness)

A composition for an optical sheet was prepared similarly while omitting the use of a light-diffusing agent, and this composition was applied in an amount estimated to form a dry film 15 μm thick with a bar coater onto a substrate composed of zinc phosphate-treated steel sheet 0.3 mm thick. The coated medium was left standing at room temperature for one hour and then forced dried at 80° C. for two hours to complete a test sample. This test sample was subjected to the pencil hardness test set forth in JIS (Japanese Industrial Standard) K5400-1900 8.4.1 (Method by Testing Machine). The pencil hardness which formed a scratch on the coating of the test sample was evaluated as the surface hardness.

(Total Light Transmittance and Haze)

The total light transmittance and the haze were determined by the use of a turbidimeter (sold by Nippon Denshoku Kogyo Co., Ltd. under the product code of “NDH-1001DP”).

(Luminance)

A produced optical sheet was put on the top surface of a light guiding plate type backlight device and tested for luminance by the use of a luminance meter (sold by TOPCON Cop. under the product code of “BM-7”).

(Evaluation of Heat Resistance)

A backlight unit incorporating the produced optical sheet was manufactured. This backlight unit was set in place in a thermostatic bath at 60° C. The time from the introduction to the occurrence of warp was measured. The presence or absence of the warp was judged by turning on the lamp of the backlight unit and examining the surface of the optical sheet to determine whether or not it was showing a sign of uneven luminance.

(Evaluation of Moisture Resistance)

The produced optical sheet was pasted with the coating face thereof held on the top side onto an aluminum sheet 0.8 mm thick, left standing for three days in an atmosphere at 50° C. and 98% RH, and visually examining the external appearance of the optical sheet. In the table, the result of this visual observation was rated on the two-point scale, wherein ∘ means no change and x means abnormal change of whitening or blistering.

### EXAMPLES 2 TO 7

Optical sheets were produced by using the Copolymers (2) to (7) shown in Table 1 as copolymers. The basic procedures for the productions of these optical sheets were the same as the procedure of Example 1 (similarly applicable herein below). The conditions of production and the results of evaluation were as shown in Table 2.

### EXAMPLES 8 AND 9

Optical sheets were produced by using colloidal silica having an average particle diameter of 15 nm (sold by Nissan Chemicals Industries, Ltd. under the trademark designation of “Snowtex”) as inorganic particle. The conditions of production and the results of evaluation were as shown in Table 2.

### EXAMPLES 10 AND 11

Optical sheets were produced without addition of a multifunctional isocyanate compound. The conditions of production and the results of evaluation were as shown in Table 2.

### EXAMPLES 12 AND 13

Optical sheets were produced by using block isocyanate (sold by Sumika Bayer Urethane Co., Ltd. under the trademark designation of “Desmodur BL-3370 MPA”) instead of Sumidur N3200. They were dried by being left standing at room temperature for one hour and then dried at 100° C. for one hour. The conditions of production and the results of evaluation were as shown in Table 2.

### EXAMPLES 14 AND 15

Optical sheets were produced by following the procedure of Example 1 while changing the inorganic oxide content. The conditions of production and the results of evaluation were as shown in Table 3.

### COMPARATIVE EXAMPLE 1

An optical sheet was produced by using the Copolymer (10) shown in Table 1 as a copolymer. The conditions of production and the results of evaluation were as shown in Table 3.

### COMPARATIVE EXAMPLE 2

An optical sheet was produced without using the inorganic particle. The conditions of production and the results of evaluation were as shown in Table 3.

### COMPARATIVE EXAMPLE 3

An optical sheet was produced by using the Copolymer (11) shown in Table 1 as a copolymer and omitting the addition of a multifunctional isocyanate. The conditions of production and the results of evaluation were as shown in Table 3.

### COMPARATIVE EXAMPLES 4 AND 5

Optical sheets were produced without using the inorganic particle. The conditions of production and the results of evaluation were as shown in Table 3.

### COMPARATIVE EXAMPLE 6

An optical sheet was produced without using the inorganic particle and a multifunctional isocyanate compound. The conditions of production and the results of evaluation were as shown in Table 3.

TABLE 1

| Copolymer | (1) | (2) | (3) | (4) | (5) | (6) | (7) | (8) | (9) | (10) | (11) |
|---|---|---|---|---|---|---|---|---|---|---|---|
| CHMA | 40.0 | | | 40.0 | 50.0 | | | 40.0 | 40.0 | | |
| CHMMA | | | | | | 40.0 | | | | | |
| 4M-CHMMA | | | | | | | 40.0 | | | | |
| IBMA | | 40.0 | | | | | | | | | |
| TBMA | | | 40.0 | 20.0 | 20.0 | 20.0 | 20.0 | | 20.0 | | |
| MMA | | | | | | | | | | 37.2 | 40.0 |
| nBMA | 37.7 | 42.9 | 32.8 | 8.1 | 15.0 | 16.7 | 20.5 | 57.1 | 39.5 | 39.3 | 51.4 |
| BA | 7.3 | | | | | | | 2.4 | | | 8.1 |
| 2EHA | | 2.1 | 12.2 | 16.9 | | 8.3 | 4.5 | | | 8.5 | |
| HEMA | 13.9 | 13.9 | 13.9 | 13.9 | 13.9 | 13.9 | 13.9 | | | 13.9 | |
| MAA | 1.1 | 1.1 | 1.1 | 1.1 | 1.1 | 1.1 | 1.1 | 0.5 | 0.5 | 1.1 | 0.5 |
| Tg (° C.) | 40 | 40 | 40 | 40 | 74 | 40 | 40 | 40 | 61 | 40 | 40 |
| Theoretical | 60 | 60 | 60 | 60 | 60 | 60 | 60 | — | — | 60 | — |
| hydroxyl value | | | | | | | | | | | |

TABLE 2

| | Ex. 1* | Ex. 2 | Ex. 3 | Ex. 4 | Ex. 5 | Ex. 6 | Ex. 7 | Ex. 8 | Ex. 9 | Ex. 10 | Ex. 11 | Ex. 12 | Ex. 13 |
|---|---|---|---|---|---|---|---|---|---|---|---|---|---|
| Copolymer | (1) | (2) | (3) | (4) | (5) | (6) | (7) | (1) | (7) | (8) | (9) | (1) | (5) |
| Inorganic | A | A | A | A | A | A | A | B | B | A | A | A | A |
| particle | | | | | | | | | | | | | |
| Inorganic | 40 | 40 | 40 | 40 | 40 | 40 | 40 | 40 | 40 | 40 | 40 | 40 | 40 |
| oxide | | | | | | | | | | | | | |
| content | | | | | | | | | | | | | |
| (wt %) | | | | | | | | | | | | | |
| Isocyanate | NCO | NCO | NCO | NCO | NCO | NCO | NCO | NCO | NCO | None | None | BNCO | BNCO |
| compound | | | | | | | | | | | | | |
| Surface | 2H | 2H | 2H | 3H | 3H | 3H | 3H | 2H | 3H | 2H | 2H | H | 2H |
| hardness | | | | | | | | | | | | | |
| Total light | 71 | 74 | 71 | 73 | 70 | 71 | 70 | 70 | 71 | 71 | 70 | 72 | 71 |
| transmittance | | | | | | | | | | | | | |
| (%) | | | | | | | | | | | | | |
| Haze (%) | 88 | 87 | 88 | 88 | 89 | 86 | 88 | 90 | 88 | 87 | 87 | 88 | 88 |
| Luminance | 1268 | 1270 | 1267 | 1263 | 1260 | 1261 | 1255 | 1232 | 1228 | 1225 | 1220 | 1266 | 1259 |
| (cd/m²) | | | | | | | | | | | | | |
| Heat | 120≦ | 120≦ | 120≦ | 120≦ | 120≦ | 120≦ | 120≦ | 120≦ | 120≦ | 96 | 96 | 120≦ | 120≦ |
| resistance | | | | | | | | | | | | | |
| Moisture | ◯ | ◯ | ◯ | ◯ | ◯ | ◯ | ◯ | ◯ | ◯ | ◯ | ◯ | ◯ | ◯ |
| resistance | | | | | | | | | | | | | |

Note
Ex 1 = Example 1

TABLE 3

| | Ex. 14* | Ex. 15 | CE 1** | CE. 2 | CE. 3 | CE. 4 | CE. 5 | CE. 6 |
|---|---|---|---|---|---|---|---|---|
| Copolymer | (1) | (1) | (10) | (10) | (11) | (4) | (5) | (8) |
| Inorganic particle | A | A | A | None | A | None | None | None |
| Inorganic oxide | 30 | 20 | 40 | 40 | 40 | 40 | 40 | 40 |
| content (wt %) | | | | | | | | |
| Isocyanate | NCO | NCO | NCO | NCO | None | NCO | NCO | None |
| compound | | | | | | | | |
| Surface hardness | 2H | H | 2H | HB | 2H | HB | F | HB |
| Total light | 73 | 74 | 74 | 75 | 73 | 70 | 71 | 71 |
| transmittance (%) | | | | | | | | |
| Haze (%) | 88 | 86 | 87 | 86 | 86 | 86 | 87 | 88 |
| Luminance | 1275 | 1278 | 1278 | 1280 | 1275 | 1273 | 1271 | 1270 |
| (cd/m²) | | | | | | | | |
| Heat resistance | 120≦ | 96 | 72 | 24 | 72 | 48 | 72 | 48 |
| Moisture resistance | ◯ | ◯ | X | X | X | ◯ | ◯ | ◯ |

Note
Ex. 14* = Example 14
CE. 1** = Comparative Example 1

As shown in Table 2 and Table 3, the optical sheets produced by using the compositions of the present invention for optical sheet excelled in various properties which are expected of optical sheet.

The optical sheets produced by using the compositions of the present invention for optical sheet allow no easy occurrence of uneven luminance on their image planes. The present invention, therefore, can contribute greatly to enhancing the durability and the reliability of a liquid crystal display device.

The entire disclosure of Japanese Patent Application No. 2003-339113 filed on Sep. 30, 2003 including specification, claims, drawings, and summary are incorporated herein by reference in its entirety.

1. A composition for an Qptical sheet, comprising:
(A) a copolymer containing at least one repeating unit selected from the group consisting of a repeating unit derived from a (meth)acrylic ester possessing a cycloalkyl group, a repeating unit derived from an iso-butyl (meth)acrylate, and a repeating unit derived from a tert-butyl (meth) acrylate;
(B) a light-diffusing agent; and
(C) an inorganic particle.

2. A composition according to claim 1, wherein the copolymer contains a repeating unit derived from a (meth) acrylic ester possessing the cycloalkyl group, and the repeating unit derived from the (meth)acrylic ester possessing the cycloalkyl group is represented by the following formula (1): 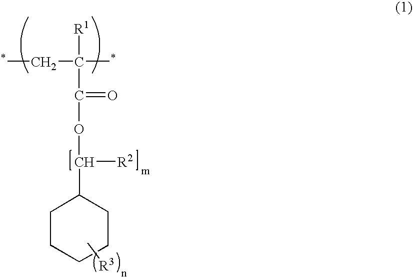
(wherein R¹ denotes hydrogen atom or methyl, R² denotes hydrogen atom, methyl, or ethyl, and R³ denotes organic group, m denotes integer of 0 to 4, n denotes an integer of 0 to 2, R² may be identical with or different from each other where m is 2 or more, and R³ may be identical with or different from each other where n is 2 or more).

3. A composition according to claim 1, wherein the inorganic particle is colloidal silica.

4. A composition according to claim 1, wherein the inorganic particle is a complex particle having an organic polymer fixed on the surface thereof, the average particle diameter of the complex particle is in the range of 5 to 200 nm, and the coefficient of variation of particle diameter of the complex particle is not more than 50%.

5. A composition according to claim 4, wherein the organic polymer possesses a hydroxyl group, and the composition further comprises a multifunctional isocyanate compound.

6. A composition according to claim 1, wherein the copolymer possesses a hydroxyl group, and the composition further comprises a multifunctional isocyanate compound.
